(19) United States
(12) Patent Application Publication
(10) Pub. No.: US 2024/0256830 A1
(43) Pub. Date: Aug. 1, 2024

(54) MACHINE LEARNING MODEL ARCHITECTURE FOR COMBINING NETWORK DATA AND SEQUENTIAL DATA

(71) Applicant: Intuit Inc., Mountain View, CA (US)

(72) Inventors: Shlomi MEDALION, Lod (IL); Yair HORESH, Kfar Sava (IL)

(73) Assignee: Intuit Inc., Mountain View, CA (US)

(21) Appl. No.: 18/104,273

(22) Filed: Jan. 31, 2023

(51) Int. Cl. G06N 3/045

(52) U.S. Cl. CPC G06N 3/045

(57) ABSTRACT

A method including building a graph data structure storing network data from a relational data structure that stores sequential data describing object identifiers and relationships between the object identifiers. The method also includes generating, from the sequential data, a features matrix for the object identifiers. The method also includes building a machine learning model layer including a long short-term memory neural network (LSTM) programmed to take, as input, the features matrix and to generate, as output, a prediction vector. The method also includes building machine learning model layers including graph convolutional neural network (GCN) layers. The machine learning model layers is programmed to take, as input, the graph data structure and the prediction vector, and generate, as output, a future prediction regarding the sequential data. The method also includes combining, into a machine learning model ensemble, the machine learning model layer and the machine learning model layers.

### BACKGROUND

Different types of machine learning models may be designed to work with different types of data. A machine learning model that is designed for one type of data may not function correctly, or may function in a manner that is not desirable.

### SUMMARY

The one or more embodiments provide for a method. The method includes building a graph data structure storing network data from a relational data structure. The relational data structure stores sequential data describing object identifiers and relationships between the object identifiers. The method also includes generating, from the sequential data of the relational data structure, a features matrix for the object identifiers. The method also includes building a machine learning model layer including a long short-term memory neural network (LSTM) programmed to take, as input, the features matrix and to generate, as output, a prediction vector. The method also includes building machine learning model layers including graph convolutional neural network (GCN) layers. The machine learning model layers is programmed to take, as input, the graph data structure and the prediction vector, and generate, as output, a future prediction regarding the sequential data. The method also includes combining, into a machine learning model ensemble, the machine learning model layer and the machine learning model layers.

The one or more embodiments provide for another method. The method includes inputting a features matrix, including sequential data regarding object identifiers, into a long short-term memory neural network (LSTM). The method also includes generating, as output from the LSTM, a first prediction vector representing a first prediction of a future state of the sequential data. The method also includes inputting the first prediction vector, a weights matrix, and a graph data structure into graph convolutional neural network (GCN) layers. The graph data structure includes network data describing relationships among the object identifiers. The method also includes generating, as output from the GCN layers, a second prediction of a future state of the sequential data.

The one or more embodiments also provide for a system. The system includes a processor and a data repository in communication with the processor. The data repository stores a relational data structure storing sequential data describing object identifiers and relationships between the object identifiers. The data repository also stores a graph data structure storing network data. The data repository also stores a features matrix for the object identifiers. The data repository also stores a prediction vector and a future prediction regarding the sequential data. The system also includes a machine learning model layer including a long short-term memory neural network (LSTM) programmed to take, as input, the features matrix and to generate, as output, the prediction vector. The system also includes machine learning model layers including graph convolutional neural network (GCN) layers. The machine learning model layers is programmed to take, as input, the graph data structure and the prediction vector, and to generate, as output, the future prediction. The system also includes a server controller which, when executed by the processor, is programmed to execute, as a machine learning model ensemble, the machine learning model layer and the machine learning model layers.

Other aspects of the one or more embodiments will be apparent from the following description and the appended claims.

### BRIEF DESCRIPTION OF DRAWINGS

FIG. 1A and FIG. 1B show a computing system, in accordance with one or more embodiments.

FIG. 2 and FIG. 3 show methods for building or using a machine learning model architecture for combining network data and sequential data, in accordance with one or more embodiments.

FIG. 4A, FIG. 4B, FIG. 4C, FIG. 4D, FIG. 4E, FIG. 4F, and FIG. 4G show examples of building or using a machine learning model architecture for combining network data and sequential data, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

In general, embodiments are directed to an improved machine learning model architecture and use of the improved machine learning model architecture. In particular, the one or more embodiments address the technical problem of how to use both sequential data and network data to generate a meaningful machine learning model prediction. The one or more embodiments address the technical problem with a technical solution that combines machine learning model layers to generate a single machine learning model, or an ensemble of machine learning models, that take both the sequential data and network data as input and then generate a meaningful output.

A more detailed summary is now presented. As indicated above, different types of machine learning models may be designed to work with different types of data. For example, certain machine learning models are designed to take sequential data (stored in a relational data structure) as input and generate a prediction of a next number in the sequential data as output. Other machine learning models are designed to take network data (stored in a graph data structure) and generate predicted relationships among the data stored in the networked data as output.

However, inputting sequential data to a network data-oriented machine learning model may generate an undesirable output. Likewise, inputting network data to a sequential data-oriented machine learning model also may generate an undesirable output. Similarly, inputting a combination of a network-oriented data and sequential data to either type of machine learning model may generate an undesirable result. The undesirable output may be nonsensical, incorrect, or suboptimal, as determined by a data scientist responsible for selecting, training, and monitoring the operation of the machine learning models.

As a result, when available source data is stored as both sequential data and network-oriented data, it may be impossible or impractical to generate predictions that are of value to the data scientist. While it may be possible to convert sequential data to network data, or vice versa, it may be impractical or undesirable to perform such a conversion. The one or more embodiments address this technical problem. Specifically, the one or more embodiments address the technical problem of generating a machine learning model, or a machine learning model ensemble, that may take both the sequential data and the network data as input and yet generate a desirable output (with “desirable” being determined by a data scientist).

Specifically, the technical solution involves combining layers of a long short-term memory machine learning model (known as an LSTM) and a graph convolutional network machine learning model (known as a GCN). The LSTM is designed to take, as input, sequential data (e.g., a series of data points describing features that vary over time) and generate, as output, a predicted next step in the series. The GCN is designed to take, as input, network-oriented data (e.g., a graph data structure described by features represented as graph nodes whose relationships are represented by graph edges) and generate, as output, predictions regarding relationships among the features. A feature is a type of data of interest, as defined further below.

The combination of the LSTM and the GCN is not straightforward, as shown in detail below. For example, the output of one model is not simply fed as the input of the other model. Rather, different layers of the LSTM and the GCN are arranged to form a new machine learning model which takes the different data forms at different points within the architecture of the new machine learning model. The one or more embodiments contemplate at least two different embodiments, a first embodiment where the GCN forms the first layers of the new machine learning model, and a second embodiment where the LSTM forms the first layers of the new machine learning model. Additional details regarding the new machine learning model are described below with respect to the Figures.

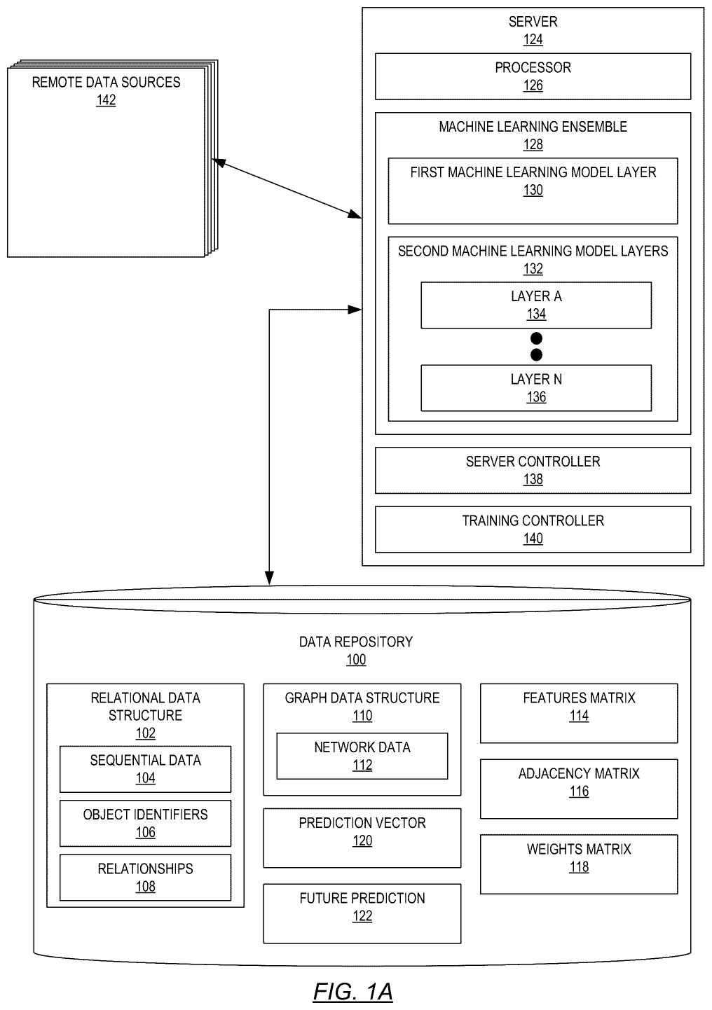

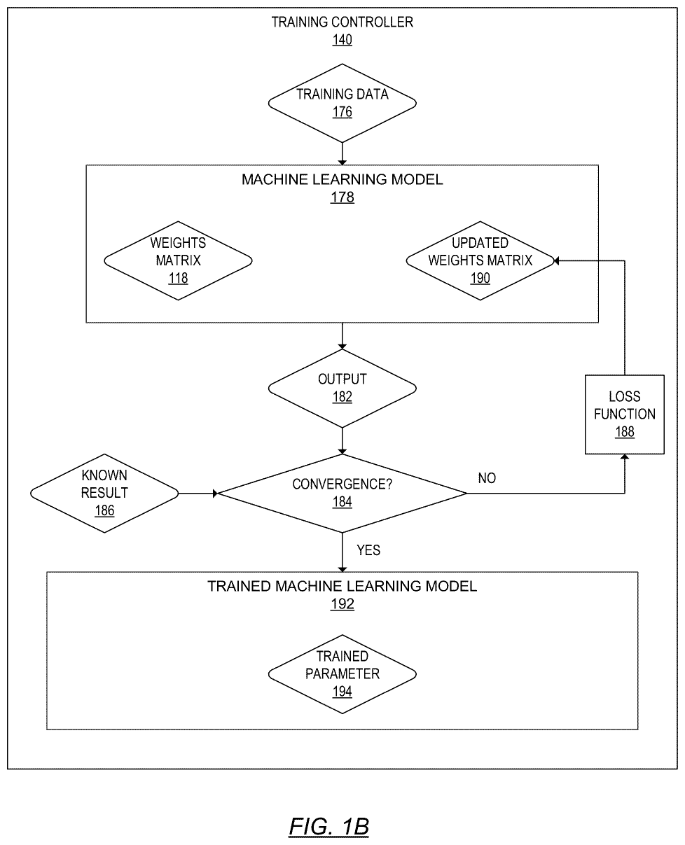

Attention is now turned to FIG. 1A and FIG. 1B. The system shown in FIG. 1A may be used to build and use a machine learning model architecture for combining network data and sequential data. The system shown in FIG. 1B shows details of the training controller shown in FIG. 1A.

The system shown in FIG. 1A includes a data repository (100). In one or more embodiments, the data repository (100) is a type of storage unit and/or device (e.g., a file system, database, data structure, or any other storage mechanism) for storing data. Further, the data repository (100) may include multiple different, potentially heterogeneous, storage units and/or devices.

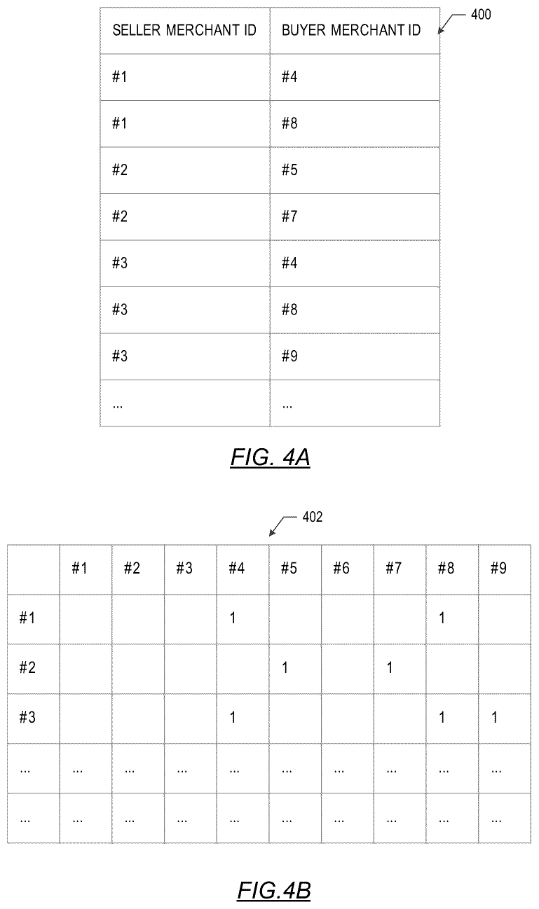

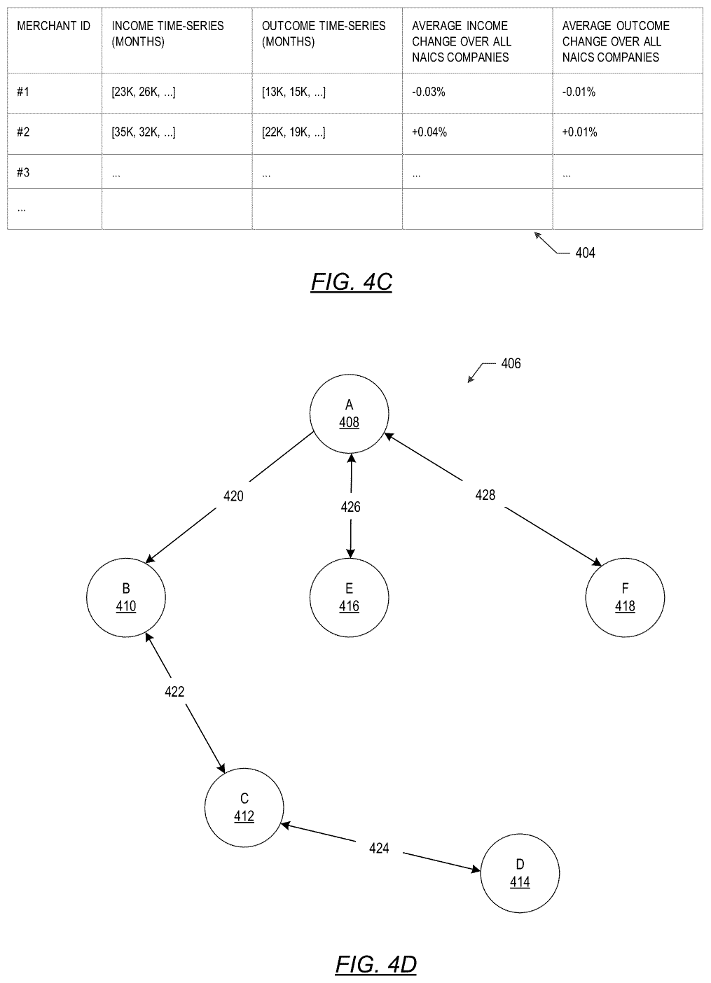

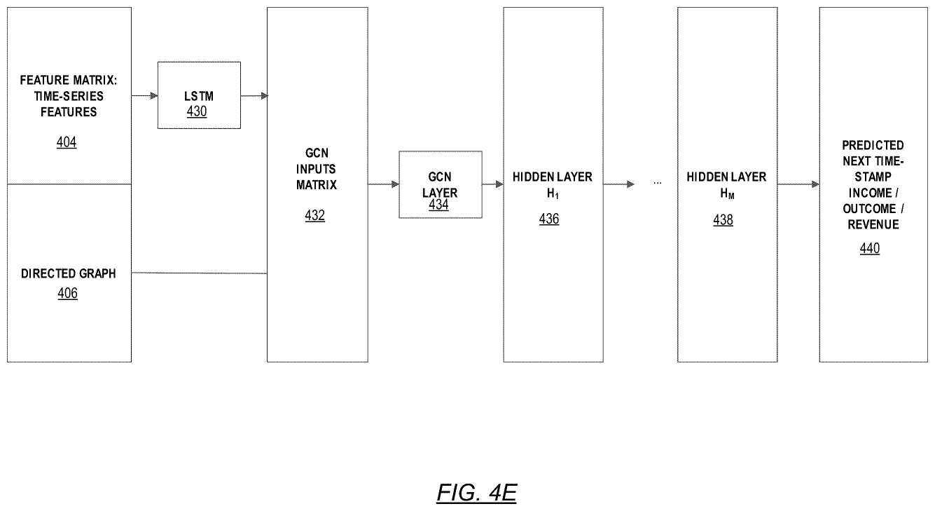

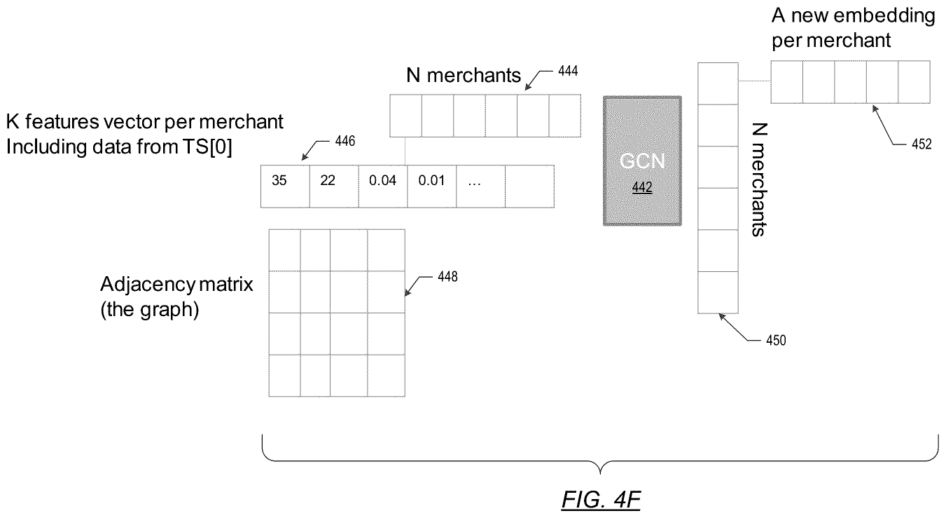

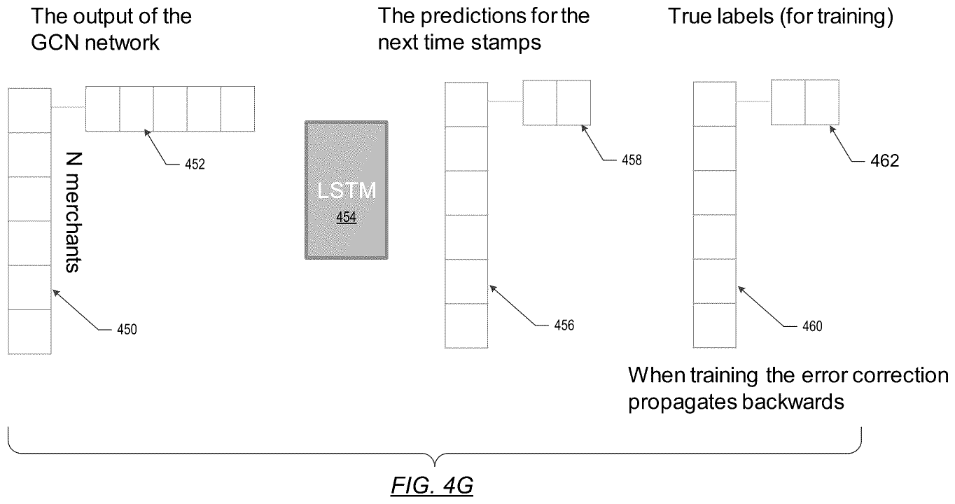

The data repository (100) stores a relational data structure (102). The relational data structure (102) is data structure based on the relational model of data The relational data structure (102) may be managed using, for example, a relational database management system (RDBMS) and may be queried using, for example, a command configured in the structured language query (SQL) language. More specifically, the relational data structure (102) is a data structure configured to store sequential data (104). The relational data structure (102) may be represented as a table or matrix. An example of the relational data structure (102) is shown in FIG. 4A.

The sequential data (104) is data that includes one or more features and, for at least one of the features, time information recorded over multiple time increments. A feature is a type of data of interest, such as a user, a description of the user, a time, or any other type of data of interest. A feature may have a numerical value (or some other symbolic scheme value) that represents a quantitative measure of the feature.

For example, in the sequential data (104), the feature may be a financial status of an entity, and the corresponding value of the feature may be a number that reflects a quantitative assessment of the financial status of the entity. Continuing the example, the sequential data (104) may include twelve values of the feature for the entity, with each value representing the financial status of the entity in one of the twelve months of the year. The relational data structure (102) may store similar information for many entities over the course of the year.

The relational data structure (102) may include a number of object identifiers (106). An object identifier is a number, alphanumeric text, or one or more symbols that represent the identity of an entity for which information is stored in the relational data structure (102). The entity may be a user, a person, a business, or some other entity. Continuing the above example, a user (i.e., one of the object identifiers (106) in this example) for whom financial information is stored may be identified by the number “1234.” In this case, the value of the object identifier for the user is “1234.”

The relational data structure (102) may include data that describes relationships (108) between the object identifiers. The relationships (108) include at least one feature whose value represents the relationship between a first entity and a second entity represented in the relational data structure (102). Continuing the above example, the feature may be “seller relationship to entity X,” and the number “1” indicates that the entity in question sells to products or services to entity X. In this specific example, the relationship between the entity in question and entity X is that the entity in question is a seller to entity X.

The data repository (100) also stores a graph data structure (110). The graph data structure (110), like the relational data structure (102) stores information about objects and relationships among the objects. However, the structure of the two data structures is difficult. In particular, the graph data structure (110) stores the objects as nodes and the relationships among the objects as edges. A node is an entity in the graph data structure (110). An edge is a defined relationship between one node and another node in the graph data structure (110). Thus, for example, the graph data structure (110) may be represented as a series of geometric symbols (e.g., circles) that represent the nodes and a series of connectors (e.g., lines) that connect each of the nodes to at least one of the other nodes. An example of the graph data structure (110) is shown in FIG. 4D.

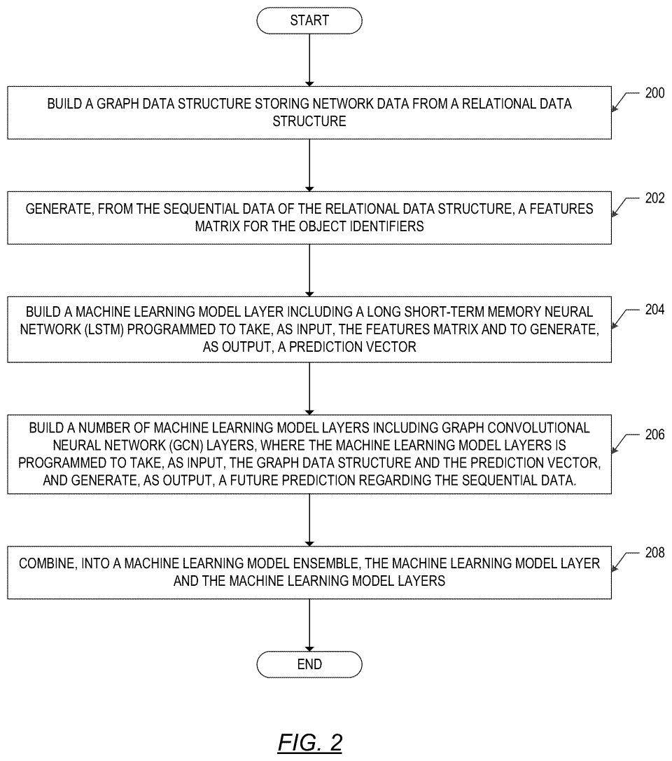

The graph data structure (110) stores network data (112). The network data (112) describes relationships among the object identifiers (106). Thus, the network data (112) may be data stored in the edges of the graph data structure (110). Note that, as described with respect to FIG. 2, the network data (112) may include the object identifiers (106) from the relational data structure (102), as in at least one embodiment the graph data structure (110) may be built from the relational data structure (102).

The data repository (100) also stores a features matrix (114). The features matrix (114) stores values for the various features in the relational data structure (102). In particular, the features matrix (114) stores the sequential data (104) regarding the object identifiers (106). An example of the features matrix (114) is shown in FIG. 4C.

The data repository (100) also may store an adjacency matrix (116). The adjacency matrix (116) stores information indicating the relationships (108) among the object identifiers (106). An example of the adjacency matrix (116) is shown in FIG. 4B.

The data repository (100) also may store a weights matrix (118). The weights matrix (118) stores numbers representing weights used in training a machine learning model. A machine learning model may include weights which may be adjusted in order to adjust an output of the machine learning model. The process of training a machine learning model, including training of an LSTM or a GCN, is described with respect to FIG. 1B. The weights matrix (118) stores the weights used during training of a machine learning model, in accordance with the one or more embodiments. The weights matrix (118) may take the form of a table (i.e., a M by N matrix), but may have additional dimensions (e.g. a M by N by O matrix, a M by N by O by P matrix, etc.).

The data repository (100) also stores a prediction vector (120). The prediction vector (120) is a vector that is output by an LSTM layer of the machine learning model or machine learning model ensemble of the one or more embodiments. A vector is a matrix of at least one dimension which stores values for features. In an embodiment, the vector is a one-dimensional matrix where each feature has one corresponding value.

More specifically, the prediction vector (120) is a vector that represents a prediction regarding a next stage in the sequential data (104). For example, the prediction vector (120) may be a vector that contains values representing different aspects of the future financial state of an entity.

The data repository (100) also stores a future prediction (122). The future prediction (122) is a number or a vector output by the machine learning model or machine learning model ensemble of the one or more embodiments. In other words, the future prediction (122) is the ultimate output that is desired, which is a prediction regarding the future state of one of the object identifiers (106). The future prediction (122) is distinguished from the prediction vector (120) in that the future prediction (122) takes into account the effect that both the relationships (108) and the sequential data (104) together have on making a prediction about one of the object identifiers (106).

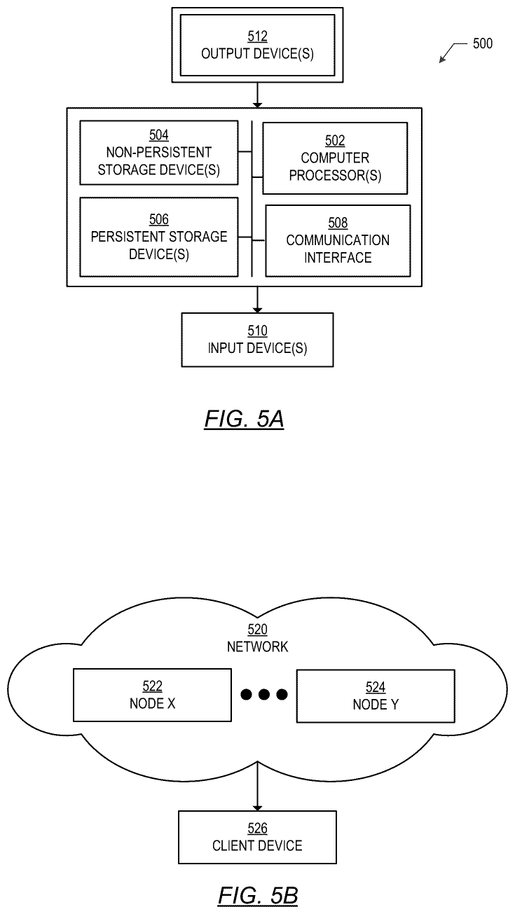

The system of FIG. 1 also includes a server (124). The server is one or more computing systems, possibly operating alone or in a distributed computing environment. An example of the server (124) is shown as the computing system shown in FIG. 5A.

The server (124) includes a processor (126). The processor (126) is one or more hardware or virtual processors, possibly executing in a distributed computing environment. An example of the processor (126) is described with respect to FIG. 5A.

The server (124) also includes a machine learning ensemble (128). The machine learning ensemble (128) is one or more machine learning models. If the machine learning ensemble (128) includes more than one machine learning model, then at least some of the machine learning models accept, as input, the output of another of the machine learning models. While the one or more embodiments contemplate that the machine learning ensemble (128) is a single machine learning model including multiple layers of different types of machine learning models, the one or more embodiments also may be viewed in some cases as multiple machine learning models acting in concert. Hence the machine learning ensemble (128) may be interpreted as a single machine learning model in some cases, and as multiple machine learning models operating in concert in other cases.

The machine learning ensemble (128) includes a first machine learning model layer (130). The term “first” is a nonce term used to distinguish the first machine learning model layer (130) from the “second” machine learning model layers (132) described further below. However, the first machine learning model layer (130), from an architectural perspective, does serve as the first layer to receive at least part of the initial input to the machine learning ensemble (128). Note, however, that the second machine learning model layers (132), described further below, receives another part of the initial input to the machine learning ensemble (128).

The second machine learning model layers (132) receive not only the other part of the initial input to the machine learning ensemble (128), but also receive, as input, the output of the first machine learning model layer (130). Thus, the second machine learning model layers (132) initially receive a combination of a part of the initial input and the output of the first machine learning model layer (130), as described below.

The second machine learning model layers (132) includes at least two layers, layer A (134) and layer N (136). The second machine learning model layers (132) may include many more layers. The layer A (134) is the first layer in the set of layers. The layer A (134) receives the combination of the output of the first machine learning model layer (130) and the part of the initial input that was not input to the first machine learning model layer (130). Each succeeding layer in the second machine learning model layers (132) receives, as input, the output of a preceding layer. The layer N (136) is the last layer in the second machine learning model layers (132). The layer N (136) receives, as input, the output of the immediately prior layer in the second machine learning model layers (132). The layer N (136) generates, as output, the future prediction (122).

In one embodiment, the first machine learning model layer (130) may be a GCN, in which case the first machine learning model layer (130) is a LSTM. This variation is shown, by way of example, in FIG. 4F and FIG. 4G. In another embodiment, the first machine learning model layer (130) may be a LSTM, in which case the second machine learning model layers (132) is the GCN. This variation is shown, by way of example, in FIG. 4E.

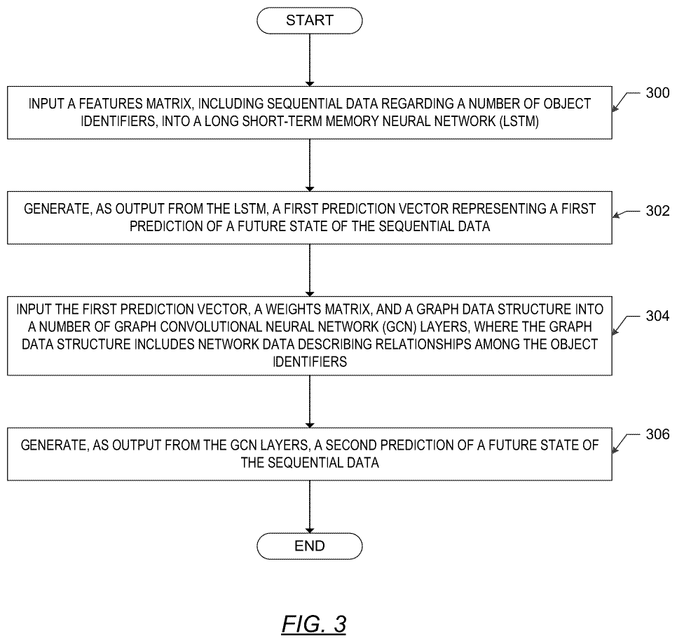

The server (124) also includes a server controller (138). The server controller (138) is software or application specific hardware programmed to execute the methods of FIG. 2 and FIG. 3, or to process the examples shown in FIG. 4A through FIG. 4G. Thus, the server controller (138) may be used to execute the machine learning ensemble (128).

The server (124) also includes a training controller (140). The training controller (140) is software or application specific hardware programmed to train the machine learning ensemble (128), including the first machine learning model layer (130) and the second machine learning model layers (132). Note that the training controller (140) is configured to tune the weights matrix (118) at each iteration of training of the layers of the machine learning ensemble (128). Details of the training controller (140) are described with respect to FIG. 1B.

Optionally, the system shown in FIG. 1 may include one or more remote data sources (142). The remote data sources (142) may be databases, data structures, remote computing systems, remote data repositories, websites, etc., that may be distinct from the data repository (100). Thus, the remote data sources (142) are not necessarily physically remote from the server (124). In some embodiments the remote data sources (142) are not part of the system shown in FIG. 1, but are merely accessed by the server (124). For example, the remote data sources (142) may include some or all of the original input data that is provided to the machine learning ensemble (128).

In a specific example, the remote data sources (142) may store historical financial information regarding many users (i.e., the object identifiers (106)). It may be desirable to use the historical financial information as input to the machine learning ensemble (128), which then may output a prediction regarding the future financial state of the users. Such example of the one or more embodiments is provided in FIG. 4A through FIG. 4G.

Attention is turned to FIG. 1B, which shows the details of the training controller (140). As described above, the training controller (140) software or application specific hardware, programmed to train one or more the machine learning models described with respect to FIG. 1A, including the machine learning ensemble (128) and the various layers, including the first machine learning model layer (130) and the second machine learning model layers (132).

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model (i.e., the trained machine learning model (192)) is applied to unknown input data in order to make predictions.

In more detail, training starts with training data (176). The training data (176) is data for which the final result is known with certainty. For example, if the machine learning task is to predict the next value or values in the sequential data (104), then the training data (176) may be a known set of the sequential data (104) for which it is already known what the predicted next value or values should be.

The training data (176) is provided as input to the machine learning model (178). The machine learning model (178), as described before, is an algorithm. However, the output of the algorithm may be changed by changing one or more parameters of the algorithm, such as the weights matrix (118) of the machine learning model (178). The weights matrix (118) may be one or more weights, the application of a sigmoid function, a hyperparameter, or possibly many different variations that may be used to adjust the output of the function of the machine learning model (178).

One or more initial values are set for the weights matrix (118). The machine learning model (178) is then executed on the training data (176). The result is a output (182), which is a prediction, a classification, a value, or some other output which the machine learning model (178) has been programmed to output.

The output (182) is provided to a convergence process (184). The convergence process (184) compares the output (182) to a known result (186). A determination is made whether the output (182) matches the known result (186) to a pre-determined degree. The pre-determined degree may be an exact match, a match to within a pre-specified percentage, or some other metric for evaluating how closely the output (182) matches the known result (186). Convergence occurs when the known result (186) matches the output (182) to within the pre-determined degree.

If convergence has not occurred (a “no” at the convergence process (184)), then a loss function (188) is generated. The loss function (188) is a program which adjusts the weights matrix (118) in order to generate an updated weights matrix (190). The basis for performing the adjustment is defined by the program that makes up the loss function (188), but may be a scheme which attempts to guess how the weights matrix (118) may be changed so that the next execution of the machine learning model (178) using the training data (176) with the updated weights matrix (190) will have an output (182) that more closely matches the known result (186).

In any case, the loss function (188) is used to specify the updated weights matrix (190). As indicated, the machine learning model (178) is executed again on the training data (176), this time with the updated weights matrix (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194).

During deployment, the trained machine learning model (192) with the trained parameter (194) is executed again, but this time on the unknown input data for which the final result is not known. The output of the trained machine learning model (192) is then treated as a prediction of the information of interest relative to the unknown data.

While FIG. 1A and FIG. 1B show a configuration of components, other configurations may be used without departing from the scope of the one or more embodiments. For example, various components may be combined to create a single component. As another example, the functionality performed by a single component may be performed by two or more components.

FIG. 2 and FIG. 3 show methods for building or using a machine learning model architecture for combining network data and sequential data, in accordance with one or more embodiments. The methods of FIG. 2 and FIG. 3 may be implemented using the system shown in FIG. 1.

Attention is first turned to the method of FIG. 2. In particular FIG. 2 shows a method of building a machine learning model ensemble, such as the machine learning ensemble (128) of FIG. 1A.

Step 200 includes building a graph data structure storing network data from a relational data structure. As indicated above, the relational data structure stores sequential data describing object identifiers and relationships between the object identifiers. The graph data structure may be the graph data structure (110) describe with respect to FIG. 1A. The relational data structure may be the relational data structure (102) of FIG. 1A. The data structures described in FIG. 2 are exemplified in FIG. 4A, FIG. 4B, and FIG. 4D, below.

The graph data structure may be built by designating the user identities in the relational data structures as nodes of the graph data structure. The relationships among the user identities edges of the graph data structure form the edges of the graph data structure.

The edges may contain additional information. For example, a strength score may be assigned to each of the edges. The strength score indicates a degree or strength of a relationship between two user identities. For example, assume the user identities relate to merchants and buyers that buy and sell to each other. The strength score between a merchant and a buyer may be determined by the fraction of a buyer's outcome that is related to the buyer's purchases from the merchant, or alternatively by a fraction of the income of the merchant that comes from a given buyer, or a combination thereof.

In an embodiment, the graph data structure may be built from the relational data structure using an intervening adjacency matrix, exemplified in FIG. 4B. Initially, the adjacency matrix may be built from the relational data structure by creating a matrix in which user identities form both rows and columns of the matrix. In this case, if a connection, relationship, or interaction exists between two user identities, then a cell of the matrix is provided with a value that indicates the existence of the connection, relationship, or interaction. The value may also indicate a strength of the connection, relationship, or interaction. Thus, the properties of the adjacency matrix may represent strength scores indicating a corresponding strength of the interactions among the user identities. In this manner, the adjacency matrix includes information indicating the connections, relationships, or interactions among the object identifiers stored in the adjacency matrix.

Then the graph data structure may be built from the adjacency matrix. Again, the user identities form nodes, and the edges are formed to connect the nodes in the manner indicated in the adjacency matrix. Optionally, one or more additional properties of the object identifiers may be encoded as metadata associated with the edges. Again, an example of an adjacency matrix is shown in FIG. 4B.

Step 202 includes generating, from the sequential data of the relational data structure, a features matrix for the object identifiers. The features matrix initially may be generated from a number of defined features. The number of defined features may be provided in a template of features in some embodiments.

Each of the user identifiers is assigned to each of the features. For example, if 700 features are defined, then each user identifier will have an entry for each of the 700 features. The values of features for any given user identifier may be taken from, or derived from, raw data. The raw data may be provided, may be retrieved or received from one or more remote data sources, or retrieved or received from some other data source.

The features of the features matrix includes time-series features that vary with time. Each time series feature has one or more entries over set of time periods.

Step 204 includes building a machine learning model layer including a long short-term memory neural network (LSTM) programmed to take, as input, the features matrix and to generate, as output, a prediction vector. Step 204 represents one of the two arrangements described above for machine learning architecture of the one or more embodiments. In step 204, the LSTM is one of the first layers of the machine learning model ensemble, as exemplified in FIG. 4E. However, as mentioned above and in the example of FIG. 4F and FIG. 4G, the GCN may be one of the first layers of the machine learning model ensemble.

Returning to step 204, the LSTM may be programmed to take, as input the features matrix by setting initial parameters or weights for the LSTM. The LSTM may be modified to receive the expected number of features in the features matrix. The LSTM is configured to generate a prediction vector as output. The prediction vector may be characterized as a single output vector in some embodiments. The prediction vector is a set of numerical predictions, of the predicted future states of the features for each of the user identifiers, at a future time step in the time series sequential data. As explained further below, the single output vector may be concatenated with one or more numerical features in the features matrix to generate an input matrix, prior to inputting the prediction vector to the GCN layers at step 206.

Step 206 includes building a number of machine learning model layers including graph convolutional neural network (GCN) layers, wherein the machine learning model layers is programmed to take, as input, the graph data structure and the prediction vector, and generate, as output, a future prediction regarding the sequential data. Again, step 206 represents one of the two arrangements described above for the machine learning architecture of the one or more embodiments. In step 206, the GCN layers are the subsequent layers of the machine learning model ensemble, as exemplified in FIG. 4E. However, as mentioned above, and in the example of FIG. 4F and FIG. 4G, the LSTM may be the subsequent layers of the machine learning model ensemble.

Returning to step 206, the GCN layers include two or more layers, including one GCN layer and a number of subsequent hidden layers. The hidden layers may include at least an initial hidden layer and a last hidden layer, though only the GCN layer and one hidden layer may be present in some embodiments.

The GCN layer, the initial layer, takes as input a combination of the graph data structure and the prediction vector that was output by the LSTM. In particular, the prediction vector and data in the graph data structure may be concatenated into an input matrix, which serves as the input to the GCN layer.

The output of the GCN layer is provided to a subsequent layer in the GCN layers, i.e., the first hidden layer in the number of subsequent hidden layers. In addition, the first hidden layer receives, as input, the adjacency matrix and a weights matrix which is tuned in a prior training process. The output of the first hidden layer is provided to a subsequent hidden layer in the number of hidden layers, together with the adjacency matrix and the weights matrix. The process continues for however many hidden layers are present in the GCN layers, until a penultimate layer (i.e., second-to-last layer) is reached.

The output of the ultimate layer (i.e., the last layer) is a final output vector. The final output vector is a series of numbers that represent a prediction regarding the sequential data initially described above. More specifically, the final output vector is a series of numbers that represent a predicted future state of the sets of features for each of the user identifiers.

In an embodiment, the ultimate layer of the GCN may be a fully connected layer. However, in another embodiment, the ultimate layer of the GCN may be another hidden layer.

While the output of the LSTM, the intervening of the GCN layers to the penultimate layer, and the output of the ultimate layer appear similar, each output changes at each output stage. Each layer finds additional hidden patterns, reinforced by the learning performed by each prior layer in the machine learning model layers of the ensemble. Additionally, the addition of the GCN layers predicts not only the future state of a given user identifier based on the past performance of that given user identifier, but also take into account the effect that other user identifiers has on the future state of the given user identifier.

In other words, the one or more embodiments represent a substantial improvement over the performance of a single LSTM or single GCN network. The improvement is that the predicted future state of the user identifiers take into account the effect of both the specific past performance of any given user identifier, but the effect that other user identifiers will have on the predicted future performance of the given user identifier. Because user identifiers may interact with each other and impact the performance of other user identifier, the one or more embodiments represent a much more nuanced and realistic approach to predicting future states of the user identifiers.

Again, the method of FIG. 2 shows an embodiment where the GCN layers are architecturally subsequent to the LSTM layer, receiving in part the output of the LSTM layer. However, as indicated above, the architectural arrangement may be reversed, where the GCN layers come first, and the output of the LSTM layer is the ultimate final prediction of the future state of the user identifiers.

An example of the machine learning model architecture that arises from the method of FIG. 2 is shown in FIG. 4E. An example of the machine learning model architecture that arises from the inverse of the method of FIG. 2 (i.e., the GCN layers are first and the LSTM layer is last) is shown in FIG. 4F and FIG. 4G.

Step 208 includes combining, into a machine learning model ensemble, the machine learning model layer and the machine learning model layers. Combining is defined as arranging the inputs and outputs of the various machine learning model layers as described above. Thus, the machine learning model ensemble may not be present on a single computing device, and may not be part of a single machine learning algorithm. However, it is also possible to arrange the machine learning model ensemble as a single machine learning algorithm executing on a single computing system. In any case, the inputs and the outputs are arranged as described above, as exemplified in FIG. 4E or exemplified in FIG. 4F and FIG. 4G.

In an embodiment, the method of FIG. 2 may terminate thereafter.

However, the method of FIG. 2 may be varied, such as by including more or fewer steps, by varying the order of steps, or by adding more detail to one or more of the steps.

For example, step 206 (building the number of machine learning model layers including the GCN layers) may include sub-steps. As indicated above, step 206 may include building a number of hidden layers. A corresponding input for each of the plurality of hidden layers includes a corresponding output of a previous hidden layer in the plurality of hidden layers, but for a first hidden layer in the plurality of hidden layers. The corresponding input also includes an adjacency matrix including information indicating relationships among the plurality of object identifiers stored in the adjacency matrix. The corresponding input also includes a weights matrix. Building the machine learning model layers of the GCN may further include adding a fully connected layer to the plurality of hidden layers.

In another variation, the method of FIG. 2 may include steps present after step 208. For example, the method of FIG. 2 may include training the machine learning model layers. Training may proceed as described with respect to FIG. 1B. Training may include tuning the weights matrix at each iteration of training the machine learning model layers. Training the machine learning model ensemble may be referred to as a training phase of machine learning.

The method of FIG. 2 also may include still more steps. For example, the method also may include using the machine learning model ensemble, constructed and then trained as described above. So using a trained machine learning model ensemble may be referred to as a deployment phase of machine learning.

In an example use case the object identifiers are a number of users. In this case, the method also includes inputting, into the machine learning model ensemble, historical data describing the users. Then, the method includes outputting, by executing the machine learning model ensemble, a future prediction regarding the users. A more specific example of use of the machine learning model ensemble of the one or more embodiments is shown in FIG. 4E through FIG. 4G.

Attention is now turned to FIG. 3. The method shown in FIG. 3 may be characterized as another method of using the machine learning model ensemble built using the method of FIG. 2.

Step 300 includes inputting a features matrix, including sequential data regarding a number of object identifiers, into a long short-term memory neural network (LSTM). The features matrix may be input in to the LSTM in the form a vector, as described above. The features matrix may be characterized as raw sequential data.

Step 302 includes generating, as output from the LSTM, a first prediction vector representing a first prediction of a future state of the sequential data. The output is generated by executing the LSTM on the input described above.

Step 304 includes inputting the first prediction vector, a weights matrix, and a graph data structure into a number of graph convolutional neural network (GCN) layers, wherein the graph data structure includes network data describing relationships among the object identifiers. As described above, the initial GCN layer receives as input a combination of the first prediction vector output by the LSTM, the weights matrix, and the graph data structure. The graph data structure may be represented as a vector, such as the adjacency matrix, in some examples. In an embodiment, prior to inputting the first prediction vector into the GCN layers, other numerical features in the feature matrix may be concatenated into the first prediction vector.

Step 306 includes generating, as output from the GCN layers, a second prediction of a future state of the sequential data. The second prediction is the ultimate prediction of the future state of the sequential data. However, again, the difference between the output of the LSTM and the second prediction (i.e., the output of the last layer of the GCN) is that the second prediction that takes into account the impact that the relationships between the user identities have on the predicted future values of the features of the user identities. In one embodiment, the method of FIG. 3 may terminate thereafter.

The method of FIG. 3 may be varied. For example, the role of the LSTM and the GCN may be reversed. As described above, the GCN may generate the initial input, which is fed to the LSTM together with the weights matrix and the sequential data or relational data. The resulting output vector is still a prediction vector that takes into account the impact that the relationships between the user identities have on the predicted future values of the features of the user identities.

In another embodiment, the GCN layers may be a number of hidden layers. In this case, inputting the first prediction vector and the graph data structure into the GCN layers includes sequentially inputting the graph data structure, the weights matrix, and a prior output of a prior hidden layer in the hidden layers into a next layer of the plurality of hidden layers. The process repeats until a last hidden layer in the hidden layers is reached.

The method of using the machine learning model ensemble shown in FIG. 3 may also include elements of building the machine learning model ensemble. For example, the method may include building an adjacency matrix from a relational data structure including the sequential data. The adjacency matrix includes information indicating relationships among the object identifiers stored in the adjacency matrix. The graph data structure may be built from the adjacency matrix.

Still other variations are possible. Thus, while the various steps in the flowcharts of FIG. 2 and FIG. 3 are presented and described sequentially, at least some of the steps may be executed in different orders, may be combined or omitted, and at least some of the steps may be executed in parallel. Furthermore, the steps may be performed actively or passively.

FIG. 4A through FIG. 4F show examples of building or using a machine learning model architecture for combining network data and sequential data, in accordance with one or more embodiments. The example may be implemented using the system shown in FIG. 1 and the methods described with respect to FIG. 2 and FIG. 3. The following example is for explanatory purposes only and not intended to limit the scope of the one or more embodiments.

The following example is set in the context of predicting a future financial state of many different merchants. It is desirable to take into account not only the past financial performance of the different merchants, but also the impact that the relationships may have on the future financial performances of the merchants.

An available data source includes information about the merchants, including buyer-seller relationships among the merchants, user identities of the merchants, and other information. The data source may be a financial management platform shared by the merchants.

FIG. 4A shows an example of the raw data in the form of source data table (400). The source data table (400) includes identities of seller merchants and the identities of buyer merchants. Each seller merchant identity is shown as selling to one or more buyer merchant identities. For example, seller merchant identity #1 sells to both merchant identity #4 and merchant identity #8.

FIG. 4B shows an example of an adjacency matrix (402). The adjacency matrix (402) more readily shows the relationships among the various merchant identities shown in the source data table (400). The adjacency matrix (402) may be used to build a directed graph or other graph data structure, as shown in FIG. 4D. The adjacency matrix (402) also may be used as described further below in the construction and use of the machine learning model ensemble.

In an embodiment, the adjacency matrix (402) may include additional information, and may take the form of a three-dimensional or higher-dimensional matrix in order to store the additional information. The additional information may include a strength of the interaction between the merchant identities. The strength may be indicated as a number less than one, rather than using the number one in the example shown in FIG. 4B. The strength score may be a fraction of the buyers outcome that is related to the buyer's purchases from a given seller, or by the fraction of income of the seller that comes from a given buyer, or by a combination thereof.

FIG. 4C shows an example of the features matrix (404). The features matrix (404) contains fields related to each specific merchant, divided to time-series features such as the income, the expenses, the revenue-time-series of previous timestamps (e.g., months), and the numeric features such as number of employees, location, etc. The features matrix (404) thus includes time-series data.

The features matrix (404) may include additional information. For example, the features matrix (404) also may include features related to the business category. The features matrix (404) may represent the aggregated features over all merchants sharing the same category codes of a business categorization system. The features matrix (404) also may include the average percentage change in income or outcome of each merchant.

FIG. 4D shows an example of a directed graph (406), which is an example of a graph data structure. The directed graph (406) includes a number of nodes, including node A (408), node B (410), node C (412), node D (414), node E (416), and node F (418). The node A (408) may be referred to as a root node, as the node A (408) is the only node directly or indirectly related to all other nodes in the directed graph (406). The node B (410), the node C (412), the node D (414), the node E (416), and the node F (418) may be referred-to as leaf nodes, as they depend in some manner from the node A (408).

The relationships between the nodes are indicated by the edges, symbolized as arrows. The edges include edge (420), edge (422), edge (424), edge (426), and edge (428). The edge (420) indicates a one-way relationship between the node A (408) and the node B (410). In this example, the merchant represented by the node A (408) sells to the merchant represented by the node B (410), but not vice versa.

However, the arrows may be bi-directional, indicating a two-way relationship between connected nodes. A two-way relationship indicates that the merchants buy and sell from each other. Thus, the edge (420) indicates a two-way relationship between the node B (410) and the node C (412). The edge (424) indicates a two-way relationship between the node C (412) and the node D (414). The edge (426) indicates a two-way relationship between the node A (408) and the node E (416). The edge (428) indicates a two-way relationship between the node A (408) and the node F (418).

The edges may store metadata, such as the strength of the relationship, the type of products exchanged, geographical supply routes, etc. The metadata may be included in, or retrieved from, the features matrix (404) shown in FIG. 4C, or may be included in or retrieved from some other data source.

FIG. 4E shows an example of the machine learning model ensemble built according to the method described with FIG. 2. As shown, a feature matrix (404), which includes time series features, is input to a LSTM layer (430). The output of the LSTM layer (430), together with the directed graph (406), are concatenated to form a GCN input matrix (432). The GCN input matrix (432) serves as input to a GCN layer (434).

The output of the GCN layer (434), together with the GCN input matrix (432), is fed as input to a first hidden layer (436), which may be designated H1. An arrangement of hidden additional layers with similar inputs and outputs as those shown for the GCN layer (434) and the first hidden layer (436) until a final hidden layer (438) is reached, which may be designated as HM.

The output of the final hidden layer (438) is the final prediction (440). The final prediction is the predicted values of the income, outcome, and revenue for each of the merchants at a next time stamp in the series of time stamps stored in the features matrix (404). The final prediction takes into account not only the time-series data in the features matrix (404), but also takes into account the impact caused by the relationships of the merchants on each other.

For example, return to the graph data structure (406) shown in FIG. 4D. Assume that each node is a merchant. Assume further that the node C (412), taken alone, may be predicted to suffer a catastrophic financial loss at a future time stamp. The prediction for the node C (412) could have been predicted solely from the time series data that pertain to the node C (412). However, if the node C (412) fails, then the income that the node B (410) derives from the node C (412) reduces, possibly to zero unless the node D (414) will do business with the node B (410). As a result, the node B (410) fails, as the sole income of the node B (410) is from the node C (412). The failure then cascades to the node A (408), which receives less revenue due to the failure of the node B (410). In this scenario, it may be possible that the node E (416) and the node F (418) also suffer, as the node A (408) may have less revenue from selling to the edge (420).

Thus, the failure of the node C (412) could have a negative impact on the income received by the node A (408), the node E (416), and the node F (418), none of which are directly related to the node C (412). Such an effect could not have been predicted if each respective merchant were only analyzed using the time series data for the each respective merchant. The effect of the relationships among the merchants would not have been taken into account, and so the ultimate prediction for each merchant would have been possibly badly erroneous.

In turn, an erroneous future prediction may lead to other negative consequences. For example, a decision may be at hand as to whether to underwrite a loan to the node E (416). If the reduced revenue expected for the node E (416) had not been predicted, then it may have been possible that the node E (416) could not have had the revenue to make loan payments, on account of the failure of the node C (412).

The one or more embodiments address the problem of the effect of interdependent relationships on predictions made from time-series financial data. Because the machine learning model ensemble shown in FIG. 4E makes future time-series predictions that take into account relationships among nodes, a more accurate prediction can be made regarding the future revenue of the node E (416).

Stated differently, the machine learning model ensemble shown in FIG. 4E is LSTM-GCN neural network which receives a raw-input matrix X from previous steps as its input. The first layer is an LSTM layer that takes the time-series vectors and outputs a single vector. The weights of this LSTM network are tuned during training.

The LSTM output vector is concatenated with other numerical features to create an input matrix X. The input matrix X is the input layer for the GCN network. At each step of the GCN, the previous layer's output is received as input, as well as the adjacency matrix (or the graph data structure) and a weights matrix which is tuned during the training process. In an embodiment, the last layer of the GCN may be a fully connected layer. The output of the fully connected layer is the predicted values of the features (e.g., next month's income, outcome and revenue) at a future time stamp for each of the merchants.

During training, the machine learning model ensemble shown in FIG. 4E may be trained as shown in FIG. 1B. The network may be trained by minimizing a L2 loss between the predicted and real next-timestamp financial values. When the network is trained over historical data, the LSTM and GCN layers weights are tuned. The weights can be used with any given historical data to predict the future financial state of the merchants (next month's income, etc.),

FIG. 4F and FIG. 4G show a variation of the machine learning model ensemble shown in FIG. 4E. In particular, the variation shown in FIG. 4F and FIG. 4G shows an architecture where the GCN layers are placed prior to the LSTM layer.

As shown in FIG. 4F, the input to the GCN (442) includes information regarding N merchants stored in the form of one or more vectors (444). Each cell in the vectors (444) includes a sub-vector, such as sub-vector (446). The sub-vector (446) includes K features, including the data from an original data at an initial time stamp designated “TS[0].” The GCN (442) also receives, as input, an adjacency matrix (448), which may be in the form of a directed graph.

The output of the GCN (442) is an output vector (450) of the N merchants. The output vector (450) includes output sub-vectors, such as sub-vector (452), that represents a new embedding for each respective merchant of the N merchants. The new embedding represents the effects that the relationships among the N merchants have each features vector (e.g., the sub-vector (446)).

Continuing the example in FIG. 4G, the output vector (450) and the sub-vector (452) are represented again for clarity of presentation and explanation. The output vector (450) (which includes the sub-vectors, such as the sub-vector (452)) is provided as input to a LSTM (454).

The output of the LSTM (454) is a final output vector (456). The final output vector (456) includes predictions of the values of the features for each merchant at a future time stamp (i.e., a future prediction of the properties of interest of the merchants, such as revenue, profits, expenses, etc.). The features may be represented as sub-vectors, such as final output sub-vector (458), that includes the predicted values for the specific features associated with a specific merchant.

The example of FIG. 4G also includes a method of updating the machine learning ensemble. Specifically, time passes and the actual true values of the features of interest may be recorded for each merchant. The true values may be designated as labels for a known result, for purposes of subsequent re-training of the machine learning model ensemble. The true values are recorded in a labeled output vector (460). The labeled output vector (460) includes a number of labeled sub-vectors, such as labeled sub-vector (462), which includes the labeled values (i.e. actual values) of the features of an individual merchant.

Then, the training procedure of FIG. 1B may be applied to the prior machine learning model ensemble. In this case, the true values represented by the labeled output vector (460) serve as the known result. During the training process, the weights (parameters) of the machine learning model ensemble are updated, as described in the iterative training process of FIG. 1B. The revised machine learning model ensemble may then be deployed for future use predicting values of the features of interest at a next subsequent future time stamp.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5A, the computing system (500) may include one or more computer processors (502), non-persistent storage (504), persistent storage (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) may be one or more cores or micro-cores of a processor. The computer processor(s) (502) includes one or more processors. The one or more processors may include a central processing unit (CPU), a graphics processing unit (GPU), a tensor processing units (TPU), combinations thereof, etc.

The input devices (510) may include a touchscreen, keyboard, mouse, microphone, touchpad, electronic pen, or any other type of input device. The input devices (510) may receive inputs from a user that are responsive to data and messages presented by the output devices (512). The inputs may include text input, audio input, video input, etc., which may be processed and transmitted by the computing system (500) in accordance with the disclosure. The communication interface (508) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the output devices (512) may include a display device, a printer, external storage, or any other output device. One or more of the output devices may be the same or different from the input device(s). The input and output device(s) may be locally or remotely connected to the computer processor(s) (502). Many different types of computing systems exist, and the aforementioned input and output device(s) may take other forms. The output devices (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include and/or perform all or a portion of one or more embodiments.

The computing system of FIG. 5A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

1. A method comprising:
building a graph data structure storing network data from a relational data structure, wherein the relational data structure stores sequential data describing a plurality of object identifiers and relationships between the plurality of object identifiers;
generating, from the sequential data of the relational data structure, a features matrix for the plurality of object identifiers;
executing a plurality of machine learning model layers comprising a plurality of graph convolutional neural network (GCN) layers, wherein executing the plurality of machine learning model layers further comprises:
executing an initial hidden layer, of the plurality of GCN layers, that takes, as input, a combination of the features matrix and the graph data structure and generates, as output, an initial hidden layer output,
executing a first hidden layer, of a number of subsequent hidden layers subsequent to the initial hidden layer of the plurality of GCN layers, that takes, as input, the initial hidden layer output, the graph data structure, and a weights matrix and generates, as output, a first hidden layer output,
executing the number of subsequent hidden layers that takes, as input, a preceding hidden layer output starting with the first hidden layer output, the graph data structure, and the weights matrix and generates, as output a penultimate layer output,
executing an ultimate layer comprising a fully connected layer programmed that takes, as input, the penultimate layer output and generates, as output, an output vector comprising a plurality of sub-vectors for each of the plurality of object identifiers, wherein the plurality of sub-vectors embed effects that relationships among the plurality of object identifiers have on the features matrix;
executing a machine learning model layer comprising a long short-term memory neural network (LSTM) that takes, as input, the output vector and generates, as output, a final output vector representing a predicted future state of the feature matrix.

2. (canceled)

3. (canceled)

4. The method of claim 1, further comprising:
training the plurality of machine learning model layers; and
tuning the weights matrix at each iteration of training the plurality of machine learning model layers.

5. (canceled)

6. The method of claim 1, wherein the final output vector further comprises a plurality of final output sub-vectors that include predicted values for specific features associated with a specific one of the plurality of object identifiers.

7. (canceled)

8. (canceled)

9. The method of claim 1, wherein:
the plurality of object identifiers comprise user identities of a plurality of users; and
the relationships comprise interactions among the plurality of users.

10. The method of claim 1, wherein the plurality of GCN layers and the LSTM together form a machine learning model ensemble, wherein the plurality of object identifiers comprise a plurality of users, and wherein the method further comprises:
inputting, into the machine learning model ensemble, historical data describing the plurality of users; and
outputting, by executing the machine learning model ensemble, a future prediction regarding the plurality of users.

11.-20. (canceled)

21. The method of claim 4, wherein the LSTM includes a second weights matrix, wherein training further comprises:
minimizing an L2 loss between a predicted timestamp and real timestamp by tuning, based on minimizing, both the weights matrix of the plurality of GCN layers and the second weights matrix of the LSTM.
